(19) United States
(12) Patent Application Publication
(10) Pub. No.: US 2025/0117671 A1
(43) Pub. Date: Apr. 10, 2025

(54) ASSESSING PERFORMANCE OF OPERATIONS IDENTIFIED FROM NATURAL LANGUAGE QUERIES

(71) Applicant: Qdeck Inc., Bellevue, WA (US)

(72) Inventors: Luke Thomas DeVos, Pittsburgh, PA (US); Timothy James Ireland, II, Bellevue, WA (US); Abigail Lynn Ireland, Bellevue, WA (US); Siu Tang Leung, Seattle, WA (US); Andrei Modoran, Bellevue, WA (US); Brad Steven Ostercamp, Carnation, WA (US); Jagdeesh Prakasam, Mercer Island, WA (US); Anandhan Jayaraman, Hyderabad (IN); Saurav Kumar, Uttar Pradesh (IN); Bharath Narla, Hyderabad (IN)

(21) Appl. No.: 18/912,428

(22) Filed: Oct. 10, 2024

Related U.S. Application Data
(60) Provisional application No. 63/589,267, filed on Oct. 10, 2023.

(51) Int. Cl. G06N 5/025; G06F 16/242

(52) U.S. Cl. CPC G06N 5/025; G06F 16/243

(57) ABSTRACT

Methods and systems are described herein for a system that enables individual users or entities to assess high-level concepts expressed in natural language by identifying quantitative evaluation criteria for evaluating the concept. For example, a query evaluation system is provided herein that receives a user's query including natural language, e.g., indicative of a higher-level concept or idea to be deployed. The system may identify quantitative evaluation criteria for evaluating the concept, perform back-testing (e.g., to see how a particular strategy would have performed in the past) and allow the user to create a specific investment portfolio that tracks the original intent of the user. The concept may be tested, and its performance evaluated before deploying it to a user portfolio.

### CROSS-REFERENCE TO RELATED APPLICATIONS

This application claims the priority benefit of U.S. Provisional Application No. 63/589,267, filed Oct. 10, 2023, entitled “SYSTEMS AND METHODS FOR ASSESSING PERFORMANCE OF OPERATIONS IDENTIFIED FROM NATURAL LANGUAGE QUERIES,” which is incorporated herein by reference in its entirety.

### BACKGROUND

Natural language Processing (NLP) systems, such as Generative Pre-trained Transformer 4 (GPT4) or Llama, transform human language into numerical representations through tokenization and encoding. These models, trained on vast text data, generate responses that are coherent and understandable to users. By learning language patterns through deep learning, NLP enables tasks like translation, summarization, and question-answering. However, NLP systems are not perfect and face challenges such as bias and inaccuracies. Continuous research and development aim to enhance these systems' capabilities and address shortcomings. NLP's potential lies in its ability to bridge the gap between human communication and machine understanding, enabling diverse applications in various fields such as virtual assistants, customer service, and more.

### SUMMARY

Understanding the impact of abstract concepts when applied to underlying systems is a challenging task in many industries. For example, while users may easily develop high level ideas for operations to perform in natural language (e.g., “I want to use more renewable energies”, “I want to use processors that have higher computing power”, “diversify my portfolio”, “buy more fintech stocks”), it is far more difficult for users to identify the impact of those ideas, such as in quantitative or qualitative measures in various dimensions (e.g., projected energy savings, lower communication overhead, projected earnings, stability, etc.). In particular, where a user has a system that utilizes exchangeable assets or resources, a user may want to exchange the assets or resources for others to improve the system, but may wish to quantitatively assess how doing so might impact performance of the system. In particular, a user may wish to do so in order to inform decisions down-stream on exchanging components of the system, such as exchanging resources such as processors of the system.

It is difficult for users to identify the impact of their ideas because users may be unable to, or not knowledgeable enough to identify and implement operations through which to execute their ideas, to identify metrics with which to evaluate their ideas, to perform the operations, and to assess the obtained metrics. Being able to do so is important because such quantitative measures serve as feedback on which to evaluate their high-level ideas. Timely feedback can be especially important in cases where ideas are time sensitive. Being able to assess user's ideas is also important in enabling users to optimize or customize operations (e.g., knowing if a user's idea can help conserve resources such as time or cost). In particular, it may be important for users to identify the potential impact of ideas prior to deploying operations that actualize their idea and/or prior to investing time and resources in implementing such operations.

As one example, a user may use multiple processors as part of a system that is used to host and execute tasks for a deployed application. The user may want to make changes to the system to align with the user's goals such as using less resources or being more eco-friendly. However, a user may not know how to translate those goals into different specifications for processors, and may not know how to identify available processors that fit a criteria for using less resources of being more eco-friendly. Furthermore, once different combinations of processors that align with a user's goals are identified, it may be difficult to identify metrics for how the system would perform without actually using the processors and calculating different values. In order to do so would conventionally require the user to transfer the application from one set of processors to the next and actively calculate different performance metrics. Not only does this require reconfiguration of the new set of processors, transferring the data to the new processors, new testing and validation, it also requires that the deployed application be temporarily unavailable as the transfer occurs.

Accordingly, a mechanism is desired that would enable individual users or entities to assess high-level concepts expressed in natural language by identifying quantitative evaluation criteria for evaluating the concept. In some examples, a system can leverage the natural language processing ability of machine learning (e.g., LLMs) to decode the text of a user's idea while guiding it to respond in a particular format that can be easily processed further to generate the performance measures of the idea.

A query evaluation system is provided herein that receives a user's query including natural language, e.g., indicative of a higher-level concept or idea to be deployed. The system may identify quantitative evaluation criteria for evaluating the concept, perform back-testing (e.g., to see how a particular strategy would have performed in the past) and allow the user to create a specific portfolio (e.g., portfolio of processing devices, investment portfolios) that tracks the original intent of the user. The concept may be tested, and its performance evaluated before deploying it to a user portfolio. In some implementations, the system may enable continuous or intermittent tracking and managing of the portfolio by actively buying new stocks or selling existing stocks in a portfolio of a user if they no longer satisfy the original intent stated intent of the user, e.g., as indicated by the query.

As described herein, a mechanism for enabling comprehension of investment ideas in natural language and conducting tests for evaluating the ideas would accelerate idea generation and testing in the financial realm. Leveraging advanced Natural language Processing (NLP) and machine learning, the system could process diverse sources to analyze the potential merits and risks of investment concepts. By democratizing investment knowledge, the system may empower both experienced investors and novices to make informed decisions, fostering financial literacy and facilitating more efficient and effective investment strategies across the market.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

Detailed descriptions of implementations of the present invention will be described and explained through the use of the accompanying drawings.

FIG. 1 shows an illustrative environment for assessing performance of operations identified from natural language queries, in accordance with one or more embodiments of this disclosure.

FIG. 2 is a block diagram of a system for assessing performance of operations identified from natural language queries, in accordance with one or more embodiments of this disclosure.

FIG. 3A illustrates a graphical interface for providing a user with metrics for performance of operations identified from natural language queries, in accordance with one or more embodiments of this disclosure.

FIG. 3B illustrates a graphical interface for adjusting parameter values by a user, in accordance with one or more embodiments of this disclosure.

FIG. 4A is a flowchart of operations for assessing performance of operations identified from natural language queries, in accordance with one or more embodiments of this disclosure.

FIG. 4B is another flowchart of operations for assessing performance of operations identified from natural language queries, in accordance with one or more embodiments of this disclosure.

FIG. 5 illustrates a computing device, in accordance with one or more embodiments of this disclosure.

FIG. 6 is a high-level block diagram illustrating an example AI system, in accordance with one or more implementations.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

In the following description, for the purposes of explanation, numerous specific details are set forth in order to provide a thorough understanding of the disclosed embodiments. It will be appreciated, however, by those having skill in the art, that the embodiments may be practiced without these specific details, or with an equivalent arrangement. In other cases, well-known models and devices are shown in block diagram form in order to avoid unnecessarily obscuring the disclosed embodiments. It should also be noted that the methods and systems disclosed herein are also suitable for applications unrelated to source code programming.

As described herein, conventional methods of quantitatively assessing high-level user concepts typically require users to translate the high-level user concepts to actionable operations. In the example where a user uses multiple processors as part of a system that is used to host and execute tasks for a deployed application, attempting to find out how the system would perform to align to “change the processors to be less resource-intensive” would only be possible if the user switched over to a new set of processors. Doing so typically causes downtime in an application executing on the processors. Furthermore, if the user wanted to iterate on the set of processors by exchanging one or more processors to compare performance, the system would be more prone to failures as it requires multiple transfers and is also more computationally expensive.

Instead, techniques are described herein that enable a user to input a high-level natural language query and obtain a quantitative assessment. The system uses machine learning to identify criteria for resources as well as criteria for exchanging. The system then performs simulations with the criteria such that the performance may be tested without, e.g., downtime for the application during deployment and reconfiguration and communication required in the transfer of the application. Once the user approves the strategy for exchanging resources based on the quantitative assessments (e.g., performance metrics), the system may then actually execute the strategy and exchange the resources.

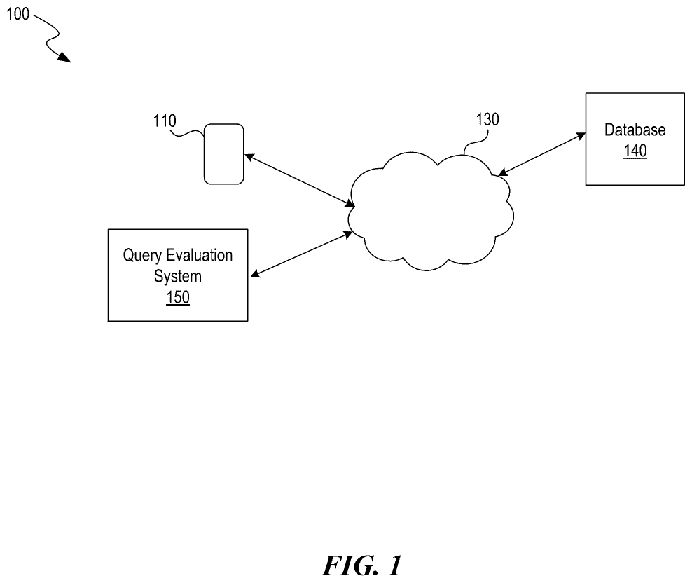

FIG. 1 shows an illustrative environment for assessing performance of operations identified from natural language queries, in accordance with one or more embodiments of this disclosure. As described herein, computing environment 100 of FIG. 1 can be used to evaluate a natural language query of a user, e.g., to create a specific investment portfolio that's tracks the original intent of the user. As referred to herein, a natural language query may refer to a query generated in human language, a language that has developed naturally in use, as contrasted with an artificial language or computer code. For example, a user at device 110 may transmit a natural language query comprising a high-level concept or idea such as “diversify my portfolio” or “buy more oil stocks but only if it is good for me”, e.g., via a network 130.

A user at the user device 110 may use one or more different input methods to input the natural language query. For example, the user can use inputs such as via keyboard inputs, gesture-based commands, voice input, eye-tracking, etc. The user device 110 may include one or more mobile devices or user equipment (UE) associated with users (such as mobile phones (e.g., smartphones), tablet computers, laptops, and so on), Internet of Things (IoT) devices, vehicles (e.g., smart vehicles), devices with sensors, and so on, can be configured to receive and transmit data, stream content, and/or perform other communications or receive services over a network 130, which is accessed by the user device(s).

The input natural language query natural language query comprising a high-level concept or idea from a user may be transmitted to the query evaluation system 150 for evaluation directly via network 130 or may be transmitted to database 140 for temporary or permanent storage and subsequently obtained by the query evaluation system 150 via network 130. As referred to herein, the network 130 may include interconnected nodes and communication links designed to transmit, receive, and exchange data packets between devices or parts of devices, e.g., based on predetermined protocols and topologies. The network may use wired or wireless components. For example, the network may include transmission mediums such as optical fibers, Ethernet cables, radio waves, telecommunication channels, and/or the like.

The query evaluation system 150 may utilize one or more machine learning models (e.g., one or more large language models (LLMs)) in understanding the obtained natural language query of the user, process the query and generate an appropriate and concise response. The query evaluation system 150 may detect any hallucinations or incorrect responses that doesn't match the required format to be testable and can regenerate the response. As referred to herein, a hallucination may refer to instances where the model generates or outputs information that does not accurately reflect the data it was trained on or is not grounded in factual or logical bases. In addition to this, the query evaluation system 150 may utilize a back-testing pipeline which can evaluate the idea and display various performance measures to the user (e.g., via a graphical display at user device 110).

FIG. 1 and the discussion herein provide a brief, general description of a suitable computing environment 100 in which the query evaluation system 150 can be supported and implemented. Although not required, aspects of the query evaluation system 150 are described in the general context of computer-executable instructions, such as routines executed by a computer, e.g., mobile device, a server computer, or personal computer. The system can be practiced with other communications, data processing, or computer system configurations, including Internet appliances, hand-held devices (including tablet computers and/or personal digital assistants (PDAs)), Internet of Things (IoT) devices, all manner of cellular or mobile phones, multi-processor systems, microprocessor-based or programmable consumer electronics, set-top boxes, network PCs, mini-computers, mainframe computers, and the like. Indeed, the terms “computer,” “host,” and “host computer,” and “mobile device” and “handset” are generally used interchangeably herein and refer to any of the above devices and systems, as well as any data processor.

Aspects of the system can be embodied in a special purpose computing device or data processor that is specifically programmed, configured, or constructed to perform one or more of the computer-executable instructions explained in detail herein. Aspects of the system can also be practiced in distributed computing environments where tasks or modules are performed by remote processing devices, which are linked through a communications network, such as a Local Area Network (LAN), Wide Area Network (WAN), or the Internet. In a distributed computing environment, program modules can be located in both local and remote memory storage devices.

Aspects of the system can be stored or distributed on computer-readable media (e.g., physical and/or tangible non-transitory computer-readable storage media), including magnetically or optically readable computer discs, hard-wired or preprogrammed chips (e.g., EEPROM semiconductor chips), nanotechnology memory, or other data storage media. Indeed, computer implemented instructions, data structures, screen displays, and other data under aspects of the system can be distributed over the Internet or over other networks (including wireless networks), on a propagated signal on a propagation medium (e.g., an electromagnetic wave(s), a sound wave, etc.) over a period of time, or they can be provided on any analog or digital network (packet switched, circuit switched, or other scheme). Portions of the system reside on a server computer, while corresponding portions reside on a client computer such as a mobile or portable device, and thus, while certain hardware platforms are described herein, aspects of the system are equally applicable to nodes on a network. In alternative implementations, the mobile device or portable device can represent the server portion, while the server can represent the client portion.

In some implementations, the user device 110 can include network communication components that enable the devices to communicate with remote servers or other portable electronic devices by transmitting and receiving wireless signals using a licensed, semi-licensed, or unlicensed spectrum over communications network, such as network 130. In some cases, the network 130 can be comprised of multiple networks, even multiple heterogeneous networks, such as one or more border networks, voice networks, broadband networks, service provider networks, Internet Service Provider (ISP) networks, and/or Public Switched Telephone Networks (PSTNs), interconnected via gateways operable to facilitate communications between and among the various networks. The network 130 can also include third-party communications networks such as a Global System for Mobile (GSM) mobile communications network, a code/time division multiple access (CDMA/TDMA) mobile communications network, a 3rd or 4th generation (3G/4G) mobile communications network (e.g., General Packet Radio Service (GPRS/EGPRS)), Enhanced Data rates for GSM Evolution (EDGE), Universal Mobile Telecommunications System (UMTS), or Long Term Evolution (LTE) network), 5G mobile communications network, IEEE 802.11 (WiFi), or other communications networks. Thus, the user device is configured to operate and switch among multiple frequency bands for receiving and/or transmitting data.

### Query Evaluation System

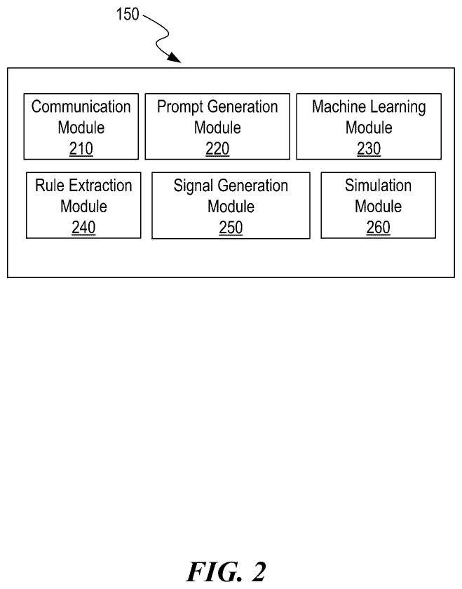

FIG. 2 is a block diagram of a system for assessing performance of operations identified from natural language queries, in accordance with one or more embodiments of this disclosure. Query evaluation system 150 includes may include software, hardware, or a combination of the two. For example, query evaluation system 150 may be a physical server or a virtual server that is running on a physical computer system. In some embodiments, query evaluation system 150 be configured on a user device (e.g., a laptop computer, a smart phone, a desktop computer, an electronic tablet, or another suitable user device). Query evaluation system 150 may include communication module 210, prompt generation module 220, machine learning module 230, rule extraction module 240, signal generation module 250, and simulation module 260.

As described herein, query evaluation system 150 may be configured to assess high-level concepts expressed in natural language by identifying quantitative evaluation criteria for evaluating the concept. For example, the user devices 110 may obtain a user's natural language query, as described herein. In one example, the query evaluation system 150 receives the query such as “I want to invest in companies that gives good dividends” and generates a prompt (e.g., a prompt augmented from the query) to input into a machine learning model configured to identify a set of criteria from the query. For example, the query evaluation system 150 can help refine and guide the model's response by providing additional context or specifying the desired format to ensure more accurate, relevant and/or tailored outputs from the model.

The machine learning model (e.g., LLM) may output a response from which rules and/or criteria for exchanging (e.g., trading) may be extracted. As referred to herein, exchanging assets or resources may be used to mean trading assets or resources, including by buying or selling the same. Once the rules are extracted, a search query is sent to the database to extract the list of stocks that satisfy the criteria. The output from the database query is used to generate buy/sell signals for all the selected stocks. The user may simulate trading using the signals and obtain metrics for performance of the signals.

### Communication Module

Query evaluation system 150 may obtain the natural language query of the user through a communication module 210 of the system. In some examples, the query evaluation system 150 can receive, from a user, a natural language query indicative of a strategy for trading during a user session at an application programming interface (API).

As described herein, a high-level query may refer to a general concept that does not explicitly indicate a trade strategy. The high-level natural language query from a user may be indicative of a direction for a strategy for trading, such as “I want stocks with high dividends” or “Get rid of high-risk stocks.” Queries may be obtained through inputs at a remote user device or locally, such as at a terminal on the query evaluation system 150. Queries may be input using various techniques, such as through keyboard input, mouse selections, touch selections, audio input, and/or gesture recognition, e.g., through sensors such as image sensors, microphones, etc.

As described herein, the query may be obtained during a user session at an API. According to some examples, the communication module 210 may also obtain user data or user session data that may be used in combination with the natural language query of the user. For example, query may be obtained during a user session at an API. For example, the user session may include a unique identifier that identifies the user session, user preferences such as settings tied to language choice, time zone, or interface customization or preferences tied to aversity to risk for trading, proclivity for certain types of stocks, etc. The user session may also identify the user and the user's account information such as types and amounts of assets or resources (e.g., stocks), as well as when they obtained or transferred (e.g., bought/sold) their assets or resources. In some examples, the user account information may also include a trading model, which may include rules or criteria for trading, as well as any algorithms associated with the rules. The session data may also include previous queries and responses which may be used to contextualize a current query.

Communication module 210 may include and use software components, hardware components, or a combination of both to obtain and transmit data to devices from the query evaluation system 150. For example, communication module 210 may include a network card (e.g., a wireless network card and/or a wired network card) that is associated with software to drive the card. Communication module 210 may pass at least a portion of the data included in the transcript, or a pointer to the data in memory, to other modules of transcript summarization system 150, such as transcript preprocessing module 220, refining module 230, prompt generation module 240, and/or machine learning module 250.

### Prompt Generation Module

As described, communication module 210 may obtain a natural language query of the user (e.g., via network 130) and may pass at least a portion of the data of the natural language query, or a pointer to the data in memory, to prompt generation module 220. The prompt generation module 220 may be configured to generate prompts based on the natural language query to input into the machine learning module 230. For example, the prompt generation module 220 may augment the user's natural language query by refining and guiding the response (e.g., output) of machine learning module 230 by providing additional context or specifying the desired format. This may in turn provide more accurate, relevant, or tailored outputs from the model. In particular, the prompt generation module 220 may generate a prompt for a machine learning model by augmenting the natural language query using session information of the user session and asset data at a knowledge base.

For example, augmenting the natural language query may include generating a search query using keywords from the natural language query. In some examples, the query evaluation system 150 may extract keywords from the natural language query and format the keywords into a search query, e.g., for a remote database. The query evaluation system 150 may use the communication module to transmit the search query to the knowledge base. The knowledge base is configured to identify asset data associated with the keywords. Once query evaluation system 150 receives the asset data associated with the keywords, the query evaluation system 150 may combine at least a portion of the asset data with the natural language query. For example, the portion of the asset data that is used may be a summarized portion of the asset data.

According to some examples, the knowledge base may include a remote or local database. The knowledge base may include information such as historical prices of assets or resources (e.g., stocks and/or crypto assets), financial reports, and/or trading volumes. In some examples, the knowledge base may include tables with stock information such as stock ticker, entity that the asset originates from (e.g., company name), exchange, sector/industry, international securities identification number (ISIN), price information such as date/time, opening price, closing price, high price, low price, volume traded, adjusted close (e.g., adjusted for dividends, stock splits), fundamental data (e.g., earnings per share, revenue, net income, dividend yield, return on equity, free cash flow, etc.) for the entity, corporate actions (e.g., stock splits, dividends, mergers, etc.).

For example, the prompt generation module may obtain user query containing natural language text or audio. The user may present their query for an investment goal as a vague statement such as “I want to invest in companies that give good dividends.” To ensure that the responses from the machine learning module 230 remain within the scope of the investment framework, the query evaluation system 150 may necessitate prompt engineering.

This may be accomplished by adding additional data to the user's initial natural language query which specifies what kind of response expected and what kind of data (overall dividend yields of all companies, dividend payout ratios, market capitalization etc.) is available in the database. This augmented prompt is then passed, at least in part, to the machine learning module 230 (e.g., comprising an LLM), which results in a response with an easily testable format. One of the key aspects of the generated prompt is that an example query and response are added to the input natural language query, allowing the model to understand the required output format.

For example, a user's natural language query of “buy when earnings report is low.” The prompt generation module 220 may determine that this is an event-driven rule and may generate the prompt “Identify rules within event-driven rules for buying stocks when the earnings report is low.” As described herein, the generated prompt may then be passed to the machine learning module 230.

### Machine Learning Module

The generated prompt may be passed to the machine learning module 230. The machine learning module 230 is configured to output a response indicative of a set of criteria. According to some examples, the machine learning module may include a large language model (LLM) capable of receiving prompts generated by the prompt generation module. As a result, the machine learning module 230 (e.g., LLM) may output the desired format of content (e.g., as indicated by the prompt generated by prompt generation module 220). According to some examples, details of available variables are added, ensuring that selections can be made from testable options. The machine learning module 230 may output a response indicative of a set of rules or criteria in the indicated format. The response may be passed to the rule extraction module 240, where rules are extracted from the response.

In some examples, the query evaluation system may input the prompt into the machine learning model to obtain a set of criteria for trading according to the natural language query. The set of criteria may include both trading rules and requirements for a type of asset to be traded. In particular, responsive to a natural language query “What would happen if I want more oil stock?” the query evaluation system may identify assets or resources relating to oil and gas as well as trading rules relating to them.

In some examples, the machine learning model may be a large language model capable of using retrieval augmented generation (RAG). For example, the LLM may convert the prompt into a query embedding capturing the semantic meaning of the query and makes it easier to compare against other documents or data in the retrieval phase. During the retrieval phase, the model may search a database, such as a knowledge base of asset information, e.g., stock data, and may retrieve the most relevant documents, such as by using ranking algorithms to score the relevance of each document to the query. The top retrieved content may then be passed to the model to provide additional context for the generative model to use when formulating a response.

In some examples, the model may also be given as part of the input, a format for the trading rules or criteria. The model may use the format so that the output adheres to the predetermined format for downstream extraction. In other examples, the model may be trained to provide the output in a specific format as well.

A “model,” as used herein, can refer to a construct that is trained using training data to make predictions or provide probabilities for new data items, whether the new data items were included in the training data. For example, training data for supervised learning can include items with various parameters and an assigned classification. A new data item can have parameters that a model can use to assign a classification to the new data item. As another example, a model can be a probability distribution resulting from the analysis of training data, such as a likelihood of an n-gram occurring in each language based on an analysis of a large corpus from that language. Examples of models include neural networks, support vector machines, decision trees, Parzen windows, Bayes, clustering, reinforcement learning, probability distributions, decision trees, decision tree forests, and others. Models can be configured for various situations, data types, sources, and output formats.

In some implementations, the model can be a large language model or a neural network with multiple input nodes that receive the prompt generated by the prompt generation module, which may include the user's natural language query and an indication of the desired format of output. The input nodes can correspond to functions that receive the input and produce results. These results can be provided to one or more levels of intermediate nodes that each produce further results based on a combination of lower-level node results. A weighting factor can be applied to the output of each node before the result is passed to the next layer node. At a final layer, (“the output layer”) one or more nodes can produce a value classifying the input that, once the model is trained, can be used to output a response to the user's query, which may be indicative of a set of rules or criteria, such as trading rules.

In some implementations, such neural networks, known as deep neural networks, can have multiple layers of intermediate nodes with different configurations, can be a combination of models that receive different parts of the input and/or input from other parts of the deep neural network, or are convolutions—partially using output from previous iterations of applying the model as further input to produce results for the current input.

A machine learning model can be trained with supervised learning, where the training data includes example queries and/or desired formats as input and a desired output, such as a response. The output from the model can be compared to the desired output, such as an expected format of the data or the type of trading rules expected, and based on the comparison, the model can be modified, such as by changing weights between nodes of the neural network or parameters of the functions used at each node in the neural network (e.g., applying a loss function). After applying each of the samples (e.g., natural language queries and desired formats for the output) in the training data and modifying the model in this manner, the model can be trained to evaluate new queries by the user.

The output parameters may be fed back to the machine learning model as input to train the machine learning model (e.g., alone or in conjunction with user indications of the accuracy of outputs, labels associated with the inputs, or other reference feedback information). The machine learning model may update its configurations (e.g., weights, biases, or other parameters) based on the assessment of its prediction (e.g., of an information source) and reference feedback information (e.g., user indication of accuracy, reference labels, or other information). Connection weights may be adjusted, for example, if the machine learning model is a neural network, to reconcile differences between the neural network's prediction and the reference feedback. One or more neurons of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the machine learning model may be trained to generate better predictions of information sources that are responsive to a query.

### Rule Extraction Module

As described herein, the rule extraction module 240 may obtain the output of the machine learning module 230, indicative of a set of rules or criteria. Upon receipt of the response, the rule extraction module may be configured to extract rules from the response by searching for strings matching the sample output format. Once these rules are identified, they are displayed to the user, e.g., via a graphical display on a user device. As referred to herein, rules and/or criteria may include trading rules, e.g., predefined criteria or guidelines that traders and investors use to make buy and sell decisions. The extracted rules may be passed to signal generation module 250.

### Signal Generation Module

Once the rules are extracted, a search query may be transmitted to a database to extract the list of stocks that satisfy the criteria. In particular, the communication module may be used to obtain, from a database, a set of resources for trading, wherein the set of resources are compliant with the requirements provided as output from the machine learning model. For example, the search query may include the criteria and may be passed to a local database or transmitted to a remote database, such as database 140 via network 130. The signal generation module 250 may receive the output from the database query, including a list of stocks that meet the criteria (e.g., for buying or selling). The output from the database query is used to generate a trading (e.g., buy/sell) signal for the resources (e.g., stocks) in consideration. One or more of the generated signals may be passed to the simulation module 260 to simulate the performance of the signals.

### Simulation Module

As described herein, the simulation module 260 may receive one or more signals generated by signal generation module 250 indicating different stocks and whether they meet criteria for buying or selling. In some examples, the simulation module 260 may be external to the query evaluation system 150 and the signals from the signal generation module 250 may be transmitted to the external simulation module via the network 130. The simulation module 260 may be configured to simulate trading e.g., by generating a daily value of the portfolio based on the expected trades.

According to some embodiments, the query evaluation system may obtain, as part of a simulation, one or more performance metrics using historical data for the set of resources. The metrics may be obtained by applying trading signals that satisfy the trading rules to the set of resourcesf during a past period of time. In particular, the simulation module 260 may use back-testing. As referred to herein, back-testing may refer to a simulation technique where the model (e.g., rule criteria) is applied to historical data to determine its effectiveness and predictability. By comparing the strategy's decisions against actual historical outcomes, traders and investors can assess the potential viability and risks of the strategy if it had been employed during a past period. For example, the simulation module 260 may be configured to collect the equity curve or the daily values of the portfolio for further processing. The system may then calculate or measure one or more performance measures of a portfolio.

In some examples, the values obtained from applying the trading rules during the simulation (e.g., a first outcome yield) can be compared to the values from applying historically optimal trade rules during the past period of time (e.g., second outcome yield). Alternatively or additionally, the values obtained from applying the trading rules during the simulation (e.g., a first outcome yield) can be compared against benchmarks such as Dow Jones Industrial Average, NASDAQ Composite, Russell 2000 Index, MSCI World Index, and/or the like. The query evaluation system may subsequently transmit commands for generating a graphical interface indicating the one or more performance metrics.

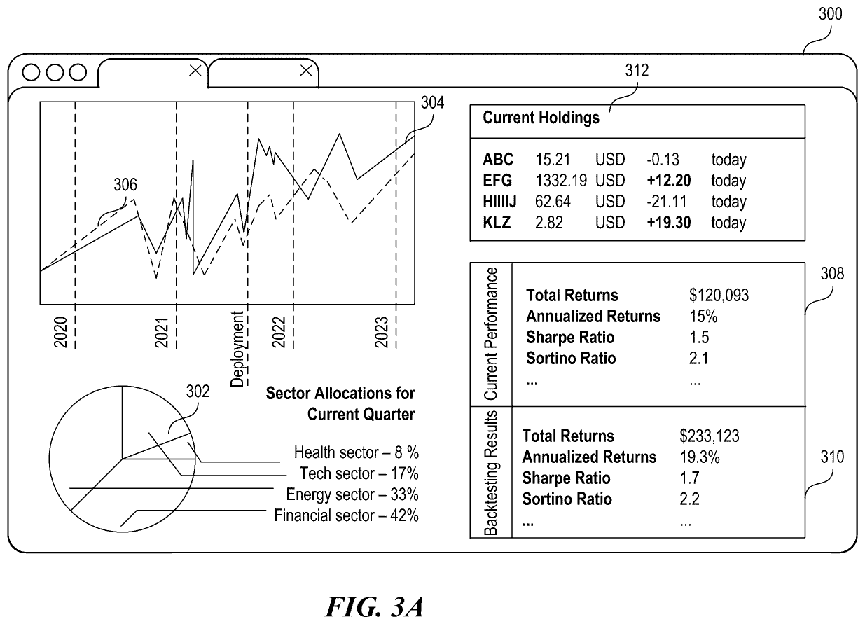

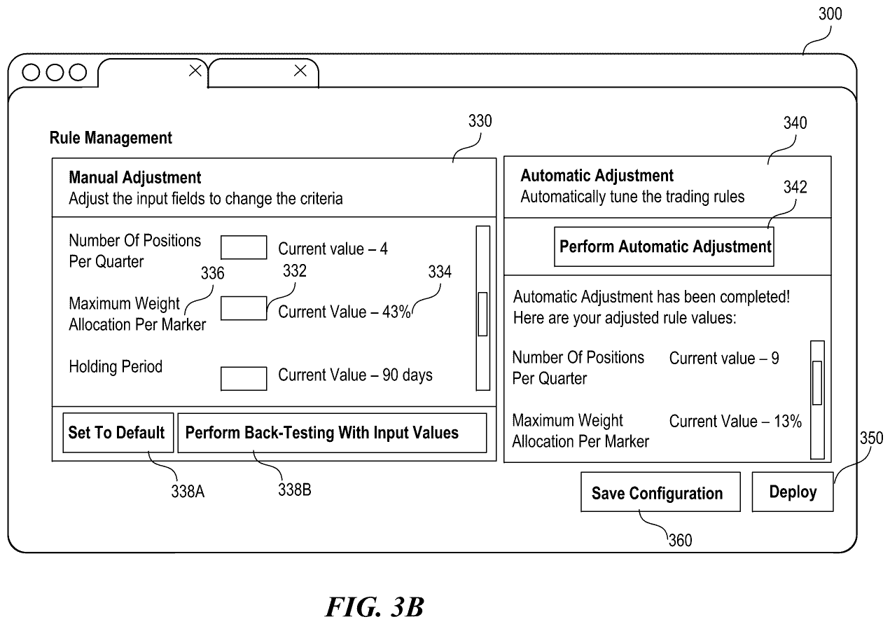

As described herein, back-testing performance metrics obtained by the simulation module 260 may be displayed to the user. Similarly, once the system deploys the strategy, either automatically or responsive to a user indication, the actual metrics of the portfolio may be tracked and displayed to the user via the graphical display (e.g., on user device 110). According to some implementations, data may be displayed on a graphical display on user device 110 (e.g., transmitted via network 130) or on a local graphical display. For example, FIG. 3A illustrates a graphical interface 300 for providing a user with metrics for performance of operations identified from natural language queries, in accordance with one or more embodiments of this disclosure. Back-testing performance metrics 310 and current performance metrics 308 are displayed for a user to view.

For each strategy deployed, the graphical interface 300 may display a chart indicating the value 304 of the user's portfolio (e.g., holdings, stocks, account assets, etc.) over time. For example, the graphical interface 300 may show the value 304 of the user's portfolio both prior to and after deployment of the generated strategy. The chart may also indicate a benchmark value 306 over time to which the value 304 of the user's portfolio may be compared. Further analytics may show the sector allocation percentages of holdings 302 in the strategy, which indicate how much of the portfolio's assets are in each sector each quarter. The dashboard also displays a list of current holdings 312 with associated prices and metrics. This allows users to view the live positions and performance resulting from the generated operations (e.g., generated trading rules and algorithms).

If, after the user reviews the strategy and the performance metric(s) and approve of the strategy, the user may indicate approval via a user device, or locally on the query evaluation system itself. Once the system receives an indication of approval for executing the trading rules for assets that fulfill the requirements in a current point in time, the system may transmit instructions for executing the trading rules through a user account.

Alternatively, or additionally the system may receive, from the user, an indication for editing the trading rules to obtain updated trading rules and responsive to receiving the indication. At any point prior to deploying the strategy, or after deploying the strategy, the user may review and adjust rule parameters to adjust the strategy. For example, FIG. 3B illustrates a graphical interface for adjusting parameter values by a user, in accordance with one or more embodiments of this disclosure. The user may tune the rules manually or automatically. For example, the system allows users to manually modify and tune the trading rules to optimize performance via a manual adjustment section 330. On the graphical interface 300, adjustable input fields such as input field 332 are provided to change rule criteria such as “maximum weight allocation per marker” 336, number of positions per quarter, and other rule parameters. A current value 334 for each rule criteria may also be displayed.

Users can modify the values using the input fields and perform back-testing by selecting option 338B “Perform Back-Testing With Input Values”, e.g., to see the impact of the modified rule criteria on performance (e.g., historical performance). A user may also revert to the previous values using option 338A “Set To Default.” Enabling users to manually tune rule criteria parameters allows users to refine strategies prior to deployment and/or prior to activating automated live trading. By enabling users to input their own values and quickly receive measurements through back-testing variations to the rule criteria, users can quickly optimize or customize the rule criteria to obtain the outputs (e.g., measurements) that they desire.

Alternatively, or additionally, the system enables users to automatically tune the rule criteria (e.g., trading rules and algorithms) by iterating through different values and optimizing the values to improve performance. For example, a user may select the option 342 “Perform Automatic Adjustment” under section 340 for automatic adjustment. The dashboard has functionality to run iterative back testing simulations (e.g., using simulation module 260), e.g., by programmatically adjusting rule parameters across wide ranges (e.g., predetermined ranges).

Performance metrics such as Sharpe ratio may be tracked to intelligently guide the search for optimal parameters. For example, the user may indicate one or more performance metrics for optimization. Alternatively or additionally, the system may identify performance metrics that are more important for a user based on the user's query or history of queries. This functionality scans the strategy design space and discover combinations of rules and inputs that maximize returns, minimize risk, and outperform benchmarks. The auto tuning transcends manual efforts through sheer compute power and automation. The best performing parameters from auto tuning can be reviewed by users. This hybrid approach combines human judgement with AI optimization to create superior trading strategies. The automatic tuning is a continual process as new market data emerges.

Other performance metrics may include return metrics indicative of the profit of the user's portfolio relative to initial investment (e.g., total return, annualized return, cumulative return), risk-adjusted return metrics (e.g., Sharpe ratio, Sortino ratio), risk metrics (e.g., standard deviation, beta, maximum drawdown), relative performance (e.g., alpha, tracking error), portfolio efficiency metrics (e.g., turnover, expense ratio), win rate, average gain versus loss, profit factor, risk/reward ratio, consistency metrics assessing the consistency of returns, slippage, commission and fees, and/or the like. The user may select or rank the metrics that are most important to the user, or the simulation module may identify and show the user those that are identified to be the most important based on the user's query. For example, if the user asks “I want stocks that are not risky in tech, and that will provide me with high return over the long run” the simulation module may rank the performance metrics such as returns, risk metrics, risk/reward ratio, and/or profit factor over others.

Once the user has adjusted the rule criteria manually or automatically, the user may select option 350 “Deploy” to deploy the model (e.g., the set of rule criteria). Deploying the model may initiate investment and placement of the trades based on the rule criteria automatically. Upon finalizing the rule criteria, the user can save the specific configuration of the model (e.g., the rule criteria) using option 360 so that they can keep monitoring the performance of the model, even if they have not deployed the model. The user may deploy the model at a later time. In some examples, the user may adjust the rule criteria through one or more additional high-level natural language queries.

Alternatively or additionally, the system may automatically or manually apply the updated trading rules to the set of assets during the past period of time as part of a second simulation. The system may then provide the user with updated performance metrics, which the user may then compare against original performance metrics when assessing which set of trading rules and criteria to proceed with. In some examples, responsive to receiving, from the user, an indication for editing the trading rules to obtain updated trading rules the system may cause retraining or updating of the machine learning model based on one or more edits to the trading rules.

### Flowcharts

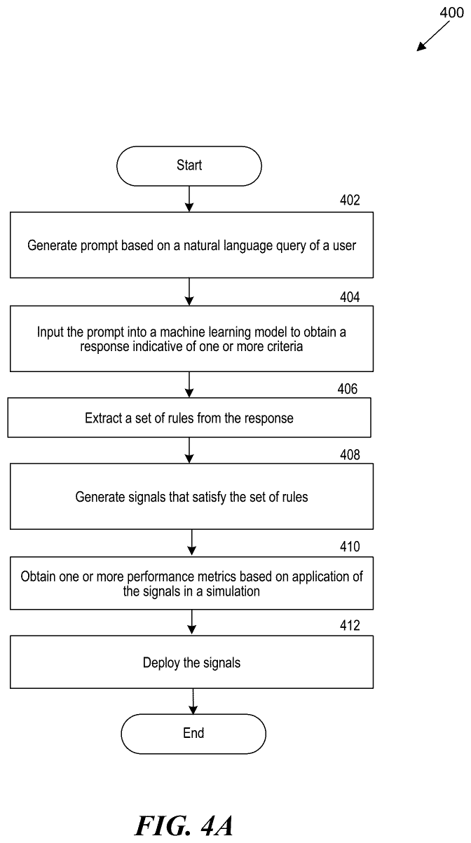

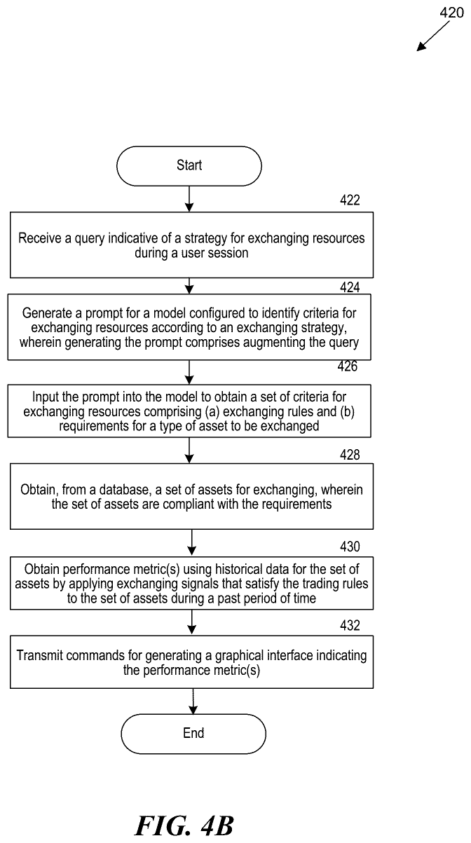

FIG. 4A is a first flowchart of operations for assessing performance of operations identified from natural language queries, in accordance with one or more embodiments of this disclosure.

Process 400 begins at block 402 where a system (e.g., such as query evaluation system 150) generates a prompt based on a natural language query of a user (as discussed above in reference to the communication module 210 and prompt generation module 220). At block 404, process 400 includes inputting the prompt into a machine learning model to obtain a response indicative of one or more criteria (as discussed above in reference to the machine learning module 230). Process 400 then proceeds to block 406 where the system extracts a set of rules from the response (as discussed in reference to the rule extraction module 240).

At block 408, process 400 includes generating signals that satisfy the set of rules (as discussed in reference to the signal generation module 250). The process proceeds to block 410, where the system obtains one or more performance metrics based on application of the signals in a simulation. At block 412, the system deploys the signals, e.g., by generating a transmitting a command.

FIG. 4B is another flowchart of operations for assessing performance of operations identified from natural language queries, in accordance with one or more embodiments of this disclosure.

Process 420 begins at block 422, where a system (e.g., such as query evaluation system 150) receives a query indicative of a strategy for exchanging during a user session. At block 424, the system may generate a prompt for a model (e.g., machine learning model) configured to identify criteria for exchanging according to an exchanging strategy, wherein generating the prompt comprises augmenting the query. Process 400 then proceeds to block 426 where the system inputs the prompt into the model to obtain a set of criteria for exchanging comprising (a) exchanging rules and (b) requirements for a type of asset to be exchanged.

At block 428, the system obtains, from a database, a set of assets for exchanging, wherein the set of assets are compliant with the requirements. The system may then obtain performance metric(s) using historical data for the set of assets by applying exchanging signals that satisfy the exchanging rules to the set of assets during a past period of time at block 430. At block 432, the system may transmit commands for generating a graphical interface indicating the performance metric(s), e.g., such as for a user.

### Computer System

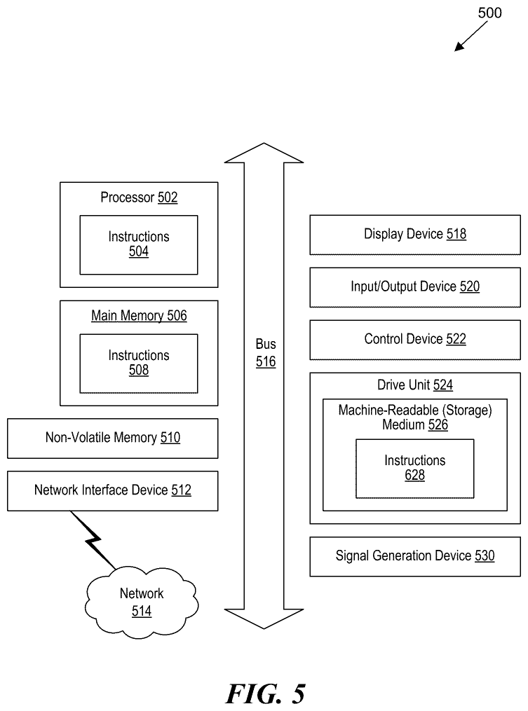

FIG. 5 is a block diagram that illustrates an example of a computer system 500 in which at least some operations described herein can be implemented. As shown, the computer system 500 can include: one or more processors 502, main memory 506, volatile and/or non-volatile memory 510, a network interface device 512, video display device 518, an input/output device 520, a control device 522 (e.g., keyboard and pointing device), a drive unit 524 that includes a storage medium 526, and a signal generation device 530 that are communicatively connected to a bus 516. The bus 516 represents one or more physical buses and/or point-to-point connections that are connected by appropriate bridges, adapters, or controllers. Various common components (e.g., cache memory) are omitted from FIG. 5 for brevity. Instead, the computer system 500 is intended to illustrate a hardware device on which components illustrated or described relative to the examples of the figures and any other components described in this specification can be implemented.

The computer system 500 can take any suitable physical form. For example, the computing system 500 shares a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 500. In some implementation, the computer system 500 can be an embedded computer system, a system-on-chip (SOC), a single-board computer system (SBC) or a distributed system such as a mesh of computer systems or include one or more cloud components in one or more networks. Where appropriate, one or more computer systems 500 can perform operations in real-time, near real-time, or in batch mode.

The network interface device 512 enables the computing system 500 to mediate data in a network 514 with an entity that is external to the computing system 500 through any communication protocol supported by the computing system 500 and the external entity. Examples of the network interface device 512 include a network adaptor card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 506, volatile and/or non-volatile memory 510, machine-readable medium 526) can be local, remote, or distributed. Although shown as a single medium, the machine-readable medium 526 can include multiple media (e.g., a centralized/distributed database and/or associated caches and servers) that store one or more sets of instructions 528. The machine-readable (storage) medium 526 can include any medium that is capable of storing, encoding, or carrying a set of instructions for execution by the computing system 500. The machine-readable medium 526 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and/or non-volatile memory devices 510, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 504, 508, 528) set at various times in various memory and storage devices in computing device(s). When read and executed by the processor 502, the instruction(s) cause the computing system 500 to perform operations to execute elements involving the various aspects of the disclosure.

### AI System

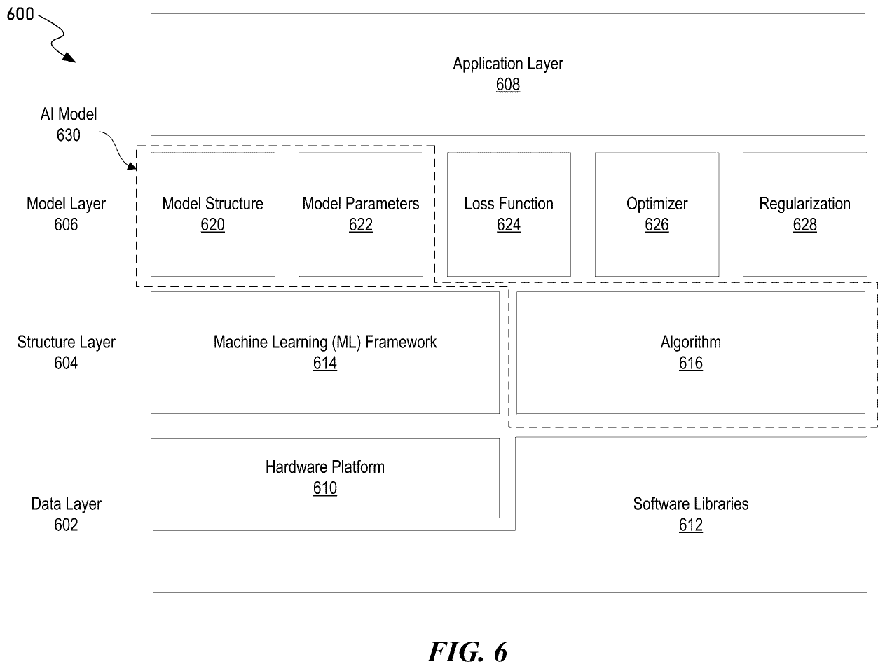

FIG. 6 is a block diagram illustrating an example artificial intelligence (AI) system 600, in accordance with one or more implementations of this disclosure. The AI system 600 is implemented using components of the example computer system 500 illustrated and described in more detail with reference to FIG. 5. For example, the AI system 600 can be implemented using the processor 502 and instructions 508 programmed in the memory 506 illustrated and described in more detail with reference to FIG. 5. Likewise, implementations of the AI system 600 can include different and/or additional components or be connected in different ways.

As shown, the AI system 600 can include a set of layers, which conceptually organize elements within an example network topology for the AI system's architecture to implement a particular Al model 630. Generally, an AI model 630 is a computer-executable program implemented by the AI system 600 that analyzes data to make predictions. Information can pass through each layer of the AI system 600 to generate outputs for the AI model 630. The layers can include a data layer 602, a structure layer 604, a model layer 606, and an application layer 608. The algorithm 616 of the structure layer 604 and the model structure 620 and model parameters 622 of the model layer 606 together form the example AI model 630. The optimizer 626, loss function engine 624, and regularization engine 628 work to refine and optimize the AI model 630, and the data layer 602 provides resources and support for application of the AI model 630 by the application layer 608.

The data layer 602 acts as the foundation of the AI system 600 by preparing data for the AI model 630. As shown, the data layer 602 can include two sub-layers: a hardware platform 610 and one or more software libraries 612. The hardware platform 610 can be designed to perform operations for the AI model 630 and include computing resources for storage, memory, logic, and networking, such as the resources described in relation to FIG. 5. The hardware platform 610 can process amounts of data using one or more servers. The servers can perform backend operations such as matrix calculations, parallel calculations, machine learning (ML) training, and the like. Examples of servers used by the hardware platform 610 include central processing units (CPUs) and graphics processing units (GPUs). CPUs are electronic circuitry designed to execute instructions for computer programs, such as arithmetic, logic, controlling, and input/output (I/O) operations, and can be implemented on integrated circuit (IC) microprocessors.

GPUs are electric circuits that were originally designed for graphics manipulation and output but can be used for AI applications due to their vast computing and memory resources. GPUs use a parallel structure that generally makes their processing more efficient than that of CPUs. In some instances, the hardware platform 610 can include Infrastructure as a Service (IaaS) resources, which are computing resources, (e.g., servers, memory, etc.) offered by a cloud services provider. The hardware platform 610 can also include computer memory for storing data about the AI model 630, application of the AI model 630, and training data for the AI model 630. The computer memory can be a form of random-access memory (RAM), such as dynamic RAM, static RAM, and non-volatile RAM.

The software libraries 612 can be thought of as suites of data and programming code, including executables, used to control the computing resources of the hardware platform 610. The programming code can include low-level primitives (e.g., fundamental language elements) that form the foundation of one or more low-level programming languages, such that servers of the hardware platform 610 can use the low-level primitives to carry out specific operations. The low-level programming languages do not require much, if any, abstraction from a computing resource's instruction set architecture, allowing them to run quickly with a small memory footprint. Examples of software libraries 612 that can be included in the AI system 600 include INTEL MATH KERNEL LIBRARY, NVIDIA CUDNN, EIGEN, AND OPEN BLAS.

The structure layer 604 can include a machine learning (ML) framework 614 and an algorithm 616. The ML framework 614 can be thought of as an interface, library, or tool that allows users to build and deploy the AI model 630. The ML framework 614 can include an open-source library, an application programming interface (API), a gradient-boosting library, an ensemble method, and/or a deep learning toolkit that work with the layers of the AI system facilitate development of the AI model 630. For example, the ML framework 614 can distribute processes for application or training of the AI model 630 across multiple resources in the hardware platform 610. The ML framework 614 can also include a set of pre-built components that have the functionality to implement and train the AI model 630 and allow users to use pre-built functions and classes to construct and train the AI model 630. Thus, the ML framework 614 can be used to facilitate data engineering, development, hyperparameter tuning, testing, and training for the AI model 630.

Examples of ML frameworks 614 or libraries that can be used in the AI system 600 include TensorFlow, PyTorch, Scikit-Learn, Keras, and Cafffe. Random Forest is a machine learning algorithm that can be used within the ML frameworks 614. LightGBM is a gradient boosting framework/algorithm (an ML technique) that can be used. Other techniques/algorithms that can be used are XGBoost, CatBoost, etc. Amazon Web Services is a cloud service provider that offers various machine learning services and tools (e.g., Sage Maker) that can be used for platform building, training, and deploying ML models.

In some implementations, the ML framework 614 performs deep learning (also known as deep structured learning or hierarchical learning) directly on the input data to learn data representations, as opposed to using task-specific algorithms. In deep learning, no explicit feature extraction is performed; the features of feature vector are implicitly extracted by the AI system 600. For example, the ML framework 614 can use a cascade of multiple layers of nonlinear processing units for implicit feature extraction and transformation. Each successive layer uses the output from the previous layer as input. The AI model 630 can thus learn in supervised (e.g., classification) and/or unsupervised (e.g., pattern analysis) modes. The AI model 630 can learn multiple levels of representations that correspond to different levels of abstraction, wherein the different levels form a hierarchy of concepts. In this manner, AI model 630 can be configured to differentiate features of interest from background features.

The algorithm 616 can be an organized set of computer-executable operations used to generate output data from a set of input data and can be described using pseudocode. The algorithm 616 can include complex code that allows the computing resources to learn from new input data and create new/modified outputs based on what was learned. In some implementations, the algorithm 616 can build the AI model 630 through being trained while running computing resources of the hardware platform 610. This training allows the algorithm 616 to make predictions or decisions without being explicitly programmed to do so. Once trained, the algorithm 616 can run at the computing resources as part of the AI model 630 to make predictions or decisions, improve computing resource performance, or perform tasks. The algorithm 616 can be trained using supervised learning, unsupervised learning, semi-supervised learning, and/or reinforcement learning.

Using supervised learning, the algorithm 616 can be trained to learn patterns (e.g., map input data to output data) based on labeled training data. The training data can be labeled by an external user or operator. For instance, a user can collect a set of training data, such as by capturing user queries or high-level concepts and trading signals or trading criteria associated with the same. The user can label the training data, e.g., label trading models (e.g., rules and/or criteria, trading signals) with high-level concepts such as “risky,” “added oil stocks,” and train the AI model 630 by inputting the training data to the algorithm 616. The algorithm determines how to label the new data based on the labeled training data. The user can facilitate collection, labeling, and/or input via the ML framework 614. In some instances, the user can convert the training data to a set of feature vectors for input to the algorithm 616. Once trained, the user can test the algorithm 616 on new data to determine if the algorithm 616 is predicting accurate labels for the new data. For example, the user can use cross-validation methods to test the accuracy of the algorithm 616 and retrain the algorithm 616 on new training data if the results of the cross-validation are below an accuracy threshold.

Supervised learning can involve classification and/or regression. Classification techniques involve teaching the algorithm 616 to identify a category of new observations based on training data and are used when input data for the algorithm 616 is discrete. Said differently, when learning through classification techniques, the algorithm 616 receives training data labeled with categories (e.g., classes) and determines how features observed in the training data (e.g., features of historical transaction data of FIG. 4) relate to the categories (e.g., services and applications). Once trained, the algorithm 616 can categorize new data by analyzing the new data for features that map to the categories. Examples of classification techniques include boosting, decision tree learning, genetic programming, learning vector quantization, k-nearest neighbor (k-NN) algorithm, and statistical classification.

Regression techniques involve estimating relationships between independent and dependent variables and are used when input data to the algorithm 616 is continuous. Regression techniques can be used to train the algorithm 616 to predict or forecast relationships between variables. To train the algorithm 616 using regression techniques, a user can select a regression method for estimating the parameters of the model. The user collects and labels training data that is input to the algorithm 616 such that the algorithm 616 is trained to understand the relationship between data features and the dependent variable(s). Once trained, the algorithm 616 can predict missing historic data or future outcomes based on input data. Examples of regression methods include linear regression, multiple linear regression, logistic regression, regression tree analysis, least squares method, and gradient descent. In an example implementation, regression techniques can be used, for example, to estimate and fill-in missing data for machine-learning based pre-processing operations.

Under unsupervised learning, the algorithm 616 learns patterns from unlabeled training data. In particular, the algorithm 616 is trained to learn hidden patterns and insights of input data, which can be used for data exploration or for generating new data. Here, the algorithm 616 does not have a predefined output, unlike the labels output when the algorithm 616 is trained using supervised learning. Another way unsupervised learning is used to train the algorithm 616 to find an underlying structure of a set of data is to group the data according to similarities and represent that set of data in a compressed format.

A few techniques can be used in supervised learning: clustering, anomaly detection, and techniques for learning latent variable models. Clustering techniques involve grouping data into different clusters that include similar data, such that other clusters contain dissimilar data. For example, during clustering, data with possible similarities remain in a group that has less or no similarities to another group. Examples of clustering techniques density-based methods, hierarchical based methods, partitioning methods, and grid-based methods. In one example, the algorithm 616 can be trained to be a k-means clustering algorithm, which partitions n observations in k clusters such that each observation belongs to the cluster with the nearest mean serving as a prototype of the cluster. Anomaly detection techniques are used to detect previously unseen rare objects or events represented in data without prior knowledge of these objects or events.

Anomalies can include data that occur rarely in a set, a deviation from other observations, outliers that are inconsistent with the rest of the data, patterns that do not conform to well-defined normal behavior, and the like. When using anomaly detection techniques, the algorithm 616 can be trained to be an Isolation Forest, local outlier factor (LOF) algorithm, or K-nearest neighbor (k-NN) algorithm. Latent variable techniques involve relating observable variables to a set of latent variables. These techniques assume that the observable variables are the result of an individual's position on the latent variables and that the observable variables have nothing in common after controlling for the latent variables. Examples of latent variable techniques that can be used by the algorithm 616 include factor analysis, item response theory, latent profile analysis, and latent class analysis.

In some implementations, the AI system 600 trains the algorithm 616 of AI model 630, based on the training data, to correlate the feature vector to expected outputs in the training data. As part of the training of the AI model 630, the AI system 600 forms a training set of features and training labels by identifying a positive training set of features that have been determined to have a desired property in question, and, in some implementations, forms a negative training set of features that lack the property in question. The AI system 600 applies ML framework 614 to train the AI model 630, that when applied to the feature vector, outputs indications of whether the feature vector has an associated desired property or properties, such as a probability that the feature vector has a particular Boolean property, or an estimated value of a scalar property. The AI system 600 can further apply dimensionality reduction (e.g., via linear discriminant analysis (LDA), PCA, or the like) to reduce the amount of data in the feature vector to a smaller, more representative set of data.

The model layer 606 implements the AI model 630 using data from the data layer and the algorithm 616 and ML framework 614 from the structure layer 604, thus enabling decision-making capabilities of the AI system 600. The model layer 606 includes a model structure 620, model parameters 622, a loss function engine 624, an optimizer 626, and a regularization engine 628.

The model structure 620 describes the architecture of the AI model 630 of the AI system 600. The model structure 620 defines the complexity of the pattern/relationship that the AI model 630 expresses. Examples of structures that can be used as the model structure 620 include decision trees, support vector machines, regression analyses, Bayesian networks, Gaussian processes, genetic algorithms, and artificial neural networks (or, simply, neural networks). The model structure 620 can include a number of structure layers, a number of nodes (or neurons) at each structure layer, and activation functions of each node. Each node's activation function defines how to node converts data received to data output. The structure layers can include an input layer of nodes that receive input data, an output layer of nodes that produce output data. The model structure 620 can include one or more hidden layers of nodes between the input and output layers. The model structure 620 can be an Artificial Neural Network (or, simply, neural network) that connects the nodes in the structured layers such that the nodes are interconnected. Examples of neural networks include Feedforward Neural Networks, convolutional neural networks (CNNs), Recurrent Neural Networks (RNNs), Autoencoder, and Generative Adversarial Networks (GANs).

The model parameters 622 represent the relationships learned during training and can be used to make predictions and decisions based on input data. The model parameters 622 can weight and bias the nodes and connections of the model structure 620. For instance, when the model structure 620 is a neural network, the model parameters 622 can weight and bias the nodes in each layer of the neural networks, such that the weights determine the strength of the nodes and the biases determine the thresholds for the activation functions of each node. The model parameters 622, in conjunction with the activation functions of the nodes, determine how input data is transformed into desired outputs. The model parameters 622 can be determined and/or altered during training of the algorithm 616.

The loss function engine 624 can determine a loss function, which is a metric used to evaluate the AI model's 630 performance during training. For instance, the loss function engine 624 can measure the difference between a predicted output of the AI model 630 and the actual output of the AI model 630 and is used to guide optimization of the AI model 630 during training to minimize the loss function. The loss function can be presented via the ML framework 614, such that a user can determine whether to retrain or otherwise alter the algorithm 616 if the loss function is over a threshold. In some instances, the algorithm 616 can be retrained automatically if the loss function is over the threshold. Examples of loss functions include a binary-cross entropy function, hinge loss function, regression loss function (e.g., mean square error, quadratic loss, etc.), mean absolute error function, smooth mean absolute error function, log-cosh loss function, and quantile loss function.

The optimizer 626 adjusts the model parameters 622 to minimize the loss function during training of the algorithm 616. In other words, the optimizer 626 uses the loss function generated by the loss function engine 624 as a guide to determine what model parameters lead to the most accurate AI model 630. Examples of optimizers include Gradient Descent (GD), Adaptive Gradient Algorithm (AdaGrad), Adaptive Moment Estimation (Adam), Root Mean Square Propagation (RMSprop), Radial Base Function (RBF) and Limited-memory BFGS (L-BFGS). The type of optimizer 626 used can be determined based on the type of model structure 620 and the size of data and the computing resources available in the data layer 602.

The regularization engine 628 executes regularization operations. Regularization is a technique that prevents over- and under-fitting of the AI model 630. Overfitting occurs when the algorithm 616 is overly complex and too adapted to the training data, which can result in poor performance of the AI model 630. Underfitting occurs when the algorithm 616 is unable to recognize even basic patterns from the training data such that it cannot perform well on training data or on validation data. The regularization engine 628 can apply one or more regularization techniques to fit the algorithm 616 to the training data properly, which helps constraint the resulting AI model 630 and improves its ability for generalized application. Examples of regularization techniques include lasso (L1) regularization, ridge (L2) regularization, and elastic (L1 and L2 regularization).

In some implementations, the AI system 600 can include a feature extraction module implemented using components of the example computer system 500 illustrated and described in more detail with reference to FIG. 5. In some implementations, the feature extraction module extracts a feature vector from input data. The feature vector includes n features (e.g., feature a, feature b, . . . , feature n). The feature extraction module reduces the redundancy in the input data, e.g., repetitive data values, to transform the input data into the reduced set of features such as feature vector. The feature vector contains the relevant information from the input data, such that events or data value thresholds of interest can be identified by the AI model 630 by using this reduced representation. In some example implementations, the following dimensionality reduction techniques are used by the feature extraction module: independent component analysis, Isomap, kernel principal component analysis (PCA), latent semantic analysis, partial least squares, PCA, multifactor dimensionality reduction, nonlinear dimensionality reduction, multilinear PCA, multilinear subspace learning, semidefinite embedding, autoencoder, and deep feature synthesis.

### Remarks

The terms “example”, “embodiment” and “implementation” are used interchangeably. For example, reference to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described which can be exhibited by some examples and not by others. Similarly, various requirements are described which can be requirements for some examples but no other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number can also include the plural or singular number respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks can be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples, but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms.

For example, aspects of a claim can be recited in a means-plus-function form or in other forms, such as being embodied in a computer-readable medium. A claim intended to be interpreted as a mean-plus-function claim will use the words “means for.” However, the use of the term “for” in any other context is not intended to invoke a similar interpretation. The applicant reserves the right to pursue such additional claim forms in either this application or in a continuing application.

What is claimed:

1. A system for providing a quantitative assessment for a high-level natural language query, the system comprising:
one or more processors; and
one or more memories configured to store instructions that when executed by the one or more processors perform operations comprising:
receiving, from a user, a natural language query indicative of a strategy for exchanging resources during a user session at an application programming interface;
generating a prompt for a machine learning model configured to identify criteria for exchanging resources according to an exchanging strategy, wherein generating the prompt comprises augmenting the natural language query using session information of the user session and resource data at a knowledge base;
inputting the prompt into the machine learning model to obtain a set of criteria for exchanging resources according to the natural language query, wherein the set of criteria comprise (a) exchanging rules and (b) requirements for a type of resource to be exchanged;
obtaining, from a database, a set of resources for exchanging, wherein the set of resources are compliant with the requirements;
obtaining, as part of a simulation, one or more performance metrics using historical data for the set of resources, wherein obtaining the one or more performance metrics comprises (1) applying exchanging signals that satisfy the exchanging rules to the set of resources during a past period of time and (2) comparing a first outcome yield of applying the exchanging signals to a second outcome yield of applying historically optimal exchange rules during the past period of time; and
transmitting commands for generating a graphical interface indicating the one or more performance metrics.

2. The system of claim 1, wherein the instructions for augmenting the natural language query using session information of the user session and resource data at a knowledge base comprises:
generating a search query using keywords from the natural language query;
transmitting the search query to the knowledge base, wherein the knowledge base is configured to identify resource data associated with the keywords; and
receiving the resource data associated with the keywords and combining at least a portion of the resource data with the natural language query.

3. The system of claim 1, wherein the instructions further cause the one or more processors to perform operations comprising:
receiving, from the user, an indication of approval for executing the exchanging rules for resources that fulfill the requirements in a current point in time; and
transmitting instructions for executing the exchanging rules through a user account.

4. The system of claim 1, wherein the instructions further cause the one or more processors to perform operations comprising:
receiving, from the user, an indication for editing the exchanging rules to obtain updated exchanging rules; and
responsive to receiving the indication, automatically applying the updated exchanging rules to the set of resources during the past period of time as part of a second simulation.

5. The system of claim 1, wherein the instructions further cause the one or more processors to perform operations comprising:
receiving, from the user, an indication for editing the exchanging rules to obtain updated exchanging rules; and
causing retraining of the machine learning model based on one or more edits to the exchanging rules.

6. The system of claim 1, wherein the instructions further cause the one or more processors to perform operations comprising: extracting the exchanging rules from the set of criteria, wherein extracting the exchanging rules comprises searching for strings matching a sample format.

7. A method for providing a quantitative assessment for a high-level natural language query, the method comprising:
receiving, from a user, a query indicative of a strategy for exchanging resources;
generating a prompt for a model configured to identify criteria for exchanging resources according to an exchanging strategy, wherein generating the prompt comprises augmenting the query;
inputting the prompt into the model to obtain a set of criteria for exchanging resources according to the query, wherein the set of criteria comprise (a) exchanging rules and (b) requirements for a type of resource to be exchanged;
obtaining, from a database, a set of resources for exchanging, wherein the set of resources are compliant with the requirements;
obtaining, as part of a simulation, one or more performance metrics using historical data for the set of resources, wherein obtaining the one or more performance metrics comprises applying exchanging signals that satisfy the exchanging rules to the set of resources during a past period of time; and
transmitting commands for generating a graphical interface indicating the one or more performance metrics.

8. The method of claim 7, wherein obtaining one or more performance metrics using historical data further comprises:
comparing a first outcome yield of applying the exchanging signals to a second outcome yield of applying historically optimal exchange rules during the past period of time.

9. The method of claim 7, wherein augmenting the query using session information of a user session and resource data at a knowledge base comprises:
generating a search query using keywords from the query;
transmitting the search query to the knowledge base, wherein the knowledge base is configured to identify resource data associated with the keywords; and
receiving the resource data associated with the keywords and combining at least a portion of the resource data with the query.

10. The method of claim 7, further comprising:
receiving, from the user, an indication of approval for executing the exchanging rules for resources that fulfill the requirements in a current point in time; and
transmitting instructions for executing the exchanging rules through a user account.

11. The method of claim 7, further comprising:
receiving, from the user, an indication for editing the exchanging rules to obtain updated exchanging rules; and
responsive to receiving the indication, automatically applying the updated exchanging rules to the set of resources during the past period of time as part of a second simulation.

12. The method of claim 7, further comprising:
receiving, from the user, an indication for editing the exchanging rules to obtain updated exchanging rules; and
causing retraining of the model based on one or more edits to the exchanging rules.

13. The method of claim 7, wherein augmenting the query comprises using session information of a user session and resource data at a knowledge base.

14. The method of claim 7, further comprising:
extracting the exchanging rules from the set of criteria, wherein extracting the exchanging rules comprises searching for strings matching a sample format.

15. One or more non-transitory computer-readable media storing instructions thereon, where the instructions when executed by one or more processors cause the one or more processors to perform operations comprising:
receiving, from a user, a query indicative of a strategy for exchanging resources during a user session;
generating a prompt for a model configured to identify criteria for exchanging resources according to an exchanging strategy, wherein generating the prompt comprises augmenting the query;
inputting the prompt into the model to obtain a set of criteria for exchanging resources according to the query, wherein the set of criteria comprise (a) exchanging rules and (b) requirements for a type of resource to be exchanged;
obtaining, from a database, a set of resources for exchanging, wherein the set of resources are compliant with the requirements;
obtaining, as part of a simulation, one or more performance metrics using historical data for the set of resources, wherein obtaining the one or more performance metrics comprises applying exchanging signals that satisfy the exchanging rules to the set of resources during a past period of time; and
transmitting commands for generating a graphical interface indicating the one or more performance metrics.

16. The one or more non-transitory computer-readable media of claim 15, wherein the instructions for obtaining one or more performance metrics using historical data further cause the one or more processors to perform operations comprising:
comparing a first outcome yield of applying the exchanging signals to a second outcome yield of applying historically optimal exchange rules during the past period of time.

17. The one or more non-transitory computer-readable media of claim 15, wherein the instructions for augmenting the query using session information of the user session and resource data at a knowledge base further cause the one or more processors to perform operations comprising:
generating a search query using keywords from the query;
transmitting the search query to the knowledge base, wherein the knowledge base is configured to identify resource data associated with the keywords; and
receiving the resource data associated with the keywords and combining at least a portion of the resource data with the query.

18. The one or more non-transitory computer-readable media of claim 15, wherein the instructions further cause the one or more processors to perform operations comprising:
receiving, from the user, an indication of approval for executing the exchanging rules for resources that fulfill the requirements in a current point in time; and
transmitting instructions for executing the exchanging rules through a user account.

19. The one or more non-transitory computer-readable media of claim 15, wherein the instructions further cause the one or more processors to perform operations comprising:
receiving, from the user, an indication for editing the exchanging rules to obtain updated exchanging rules; and
responsive to receiving the indication, automatically applying the updated exchanging rules to the set of resources during the past period of time as part of a second simulation.

20. The one or more non-transitory computer-readable media of claim 15, wherein the instructions further cause the one or more processors to perform operations comprising:
receiving, from the user, an indication for editing the exchanging rules to obtain updated exchanging rules; and
causing retraining of the model based on one or more edits to the exchanging rules.
